(19) United States
(12) Patent Application Publication
(10) Pub. No.: US 2026/0140529 A1
(43) Pub. Date: May 21, 2026

(54) ROTARY DAMPER FOR FOOT CONTROL DEVICE

(71) Applicant: Garmin International, Inc., Olathe, KS (US)

(72) Inventors: Adam J. Rosploch, Olathe, KS (US); Clifford C. Hoschouer, Olathe, KS (US)

(21) Appl. No.: 19/391,696

(22) Filed: Nov. 17, 2025

Related U.S. Application Data
(60) Provisional application No. 63/721,148, filed on Nov. 15, 2024.

(51) Int. Cl. G05G 5/03; G05G 1/44

(52) U.S. Cl. CPC G05G 5/03; G05G 1/44; G05G 2505/00

(57) ABSTRACT

A foot pedal comprising a base, a pivot assembly, and a foot platform. The pivot assembly includes an outer sheath and an inner axle assembly. The inner axle assembly comprises an outer friction ring and an inner friction ring. The pivot assembly further comprises at least one retaining mechanism configured to selectively restrict rotation of the at least one outer friction ring with respect to the outer sheath. When the at least one retaining mechanism restricts rotation of the outer friction ring, the pivot assembly is in a first configuration. When the at least one retaining mechanism does not restrict rotation of the outer friction ring, the pivot assembly is in a second configuration. The pivot assembly is configured to impart different damping forces against rotation of the foot platform based on whether the pivot assembly is in either the first configuration or the second configuration.

### CROSS-REFERENCE TO RELATED APPLICATION

The present non-provisional patent application claims priority to U.S. Provisional Patent Application Serial No. 63/721,148, filed on November 15, 2024, and entitled “ROTARY DAMPER FOR FOOT CONTROL DEVICE.” The entirety of the above-identified provisional patent application is hereby incorporated by reference into the present non-provisional patent application.

### FIELD

Embodiments of the present invention are directed to a foot pedal for a trolling motor. More particularly, embodiments of the present invention are directed to a foot pedal for a trolling motor, with the foot pedal configured with adjustable rotational damping.

### DESCRIPTION OF RELATED ART

Marine vessels such as sport fishing boats or bass boats used by sport fishermen typically employ a primary motor (e.g., a propulsion motor) that propels the marine vessel through the water and one or more trolling motors that can be used instead of or in addition to the propulsion motor in certain situations. For example, a trolling motor may be used instead of the propulsion motor when navigating the marine vessel through environments that require precise control of the vessel's position (e.g., navigating around obstacles and/or in shallow water). Similarly, a sport fisherman may use the trolling motor to maintain the position of the marine vessel while fishing in situations where currents or wind may tend to cause the vessel to drift while the propulsion motor is idle.

Trolling motors are normally mounted to either or both the bow of the marine vessel or the transom of the marine vessel adjacent to the propulsion motor. Typically, trolling motors include a drive motor and propeller that can be lifted out of the water to reduce drag while the propulsion motor is in use. Trolling motors can be controlled manually using controls that are located directly on the motor, but it is often useful for a trolling motor to be controlled by a foot pedal, leaving the operator's hands free for performing other tasks, such as fishing.

Foot pedals for trolling motors may incorporate dampers to offer resistance during user engagement. These dampers can be configured to provide a controlled level of resistance against the pivoting movement of the foot pedal, enhancing stability during operation. Dampers used in foot pedal controls are typically large components, which can increase the overall dimensions of the foot pedal assembly. This added bulk may result from the size of the damper housing, as well as any supporting structures necessary to integrate the damper with the foot pedal mechanism. Due to their construction, these dampers often lack external adjustability, making it difficult for users to modify resistance settings without disassembling or replacing the damper itself.

### SUMMARY

Embodiments of the present invention include a trolling motor foot pedal comprising a base, a pivot assembly, and a foot platform configured to pivotally rotate, via the pivot assembly, with respect to the base. The pivot assembly includes an outer sheath and an inner axle assembly. The outer sheath and at least a portion of the inner axle assembly are configured to relatively rotate with respect to each other. The inner axle assembly comprises an axle, at least one outer friction ring, and at least one inner friction ring. The at least one inner friction ring is configured to selectively rotate with respect to the at least one outer friction ring. The pivot assembly further comprises at least one retaining mechanism configured to selectively restrict rotation of the at least one outer friction ring with respect to the outer sheath. When the at least one retaining mechanism restricts rotation of the at least one outer friction ring with respect to the outer sheath, the pivot assembly is in a first configuration. When the at least one retaining mechanism does not restrict rotation of the at least one outer friction ring with respect to the outer sheath, the pivot assembly is in a second configuration. The pivot assembly is configured to impart different damping forces against rotation of the foot platform based on whether the pivot assembly is in either the first configuration or the second configuration.

A trolling motor foot pedal comprising a base, a pivot assembly, and a foot platform configured to pivotally rotate, via the pivot assembly, with respect to the base. The pivot assembly includes an outer sheath and an inner axle assembly. The outer sheath and at least a portion of the inner axle assembly are configured to relatively rotate with respect to each other. The inner axle assembly comprises an axle, at least one outer friction ring, and at least one inner friction ring. The at least one inner friction ring is configured to selectively rotate with respect to the outer friction ring. The pivot assembly further comprises at least one retaining mechanism configured to selectively restrict rotation of the at least one outer friction ring with respect to the outer sheath. The pivot assembly is configured to impart a different damping force against rotation of the foot platform when the at least one retaining mechanism restricts rotation of the at least one outer friction ring than when the at least one retaining mechanism does not restrict rotation of the at least one outer friction ring.

Embodiments of the present invention further include a method of adjusting a rotational damping force of a trolling motor foot pedal. The method comprises a step of rotationally supporting, via a pivot assembly, a foot platform with respect to a base. The pivot assembly comprises an outer sheath and an inner axle assembly. At least a portion of the inner axle assembly is configured to selectively rotate with respect to the outer sheath. The inner axle assembly comprises an axle, an outer friction ring, and an inner friction ring. The inner friction ring is configured to selectively rotate with respect to the outer friction ring. An additional step includes rotating the foot platform with respect to the base, with the pivot assembly being configured to impart a first damping force against rotation of the foot platform. An additional step includes engaging at least one retaining mechanism between the outer friction ring and the outer sheath. After the engaging step, a further step includes rotating the foot platform with respect to the base, with the pivot assembly being configured to impart a second damping force against rotation of the foot platform. The second damping force is different than the first damping force.

This summary is not intended to identify essential features of the present invention, and is not intended to be used to limit the scope of the claims. These and other aspects of the present invention are described below in greater detail.

### BRIEF DESCRIPTION OF THE DRAWINGS

Embodiments of the present invention are described in detail below with reference to the attached drawing figures, wherein:

FIG. 1 is a top perspective view of a foot pedal for a trolling motor according to embodiments of the present invention;

FIG. 2 is a rear perspective view of the foot pedal from FIG. 1;

FIG. 3 is a side perspective view of the foot pedal from FIGS. 1 and 2, with a foot platform of the foot pedal rotated rearward;

FIG. 4 is another side perspective view of the foot pedal from FIGS. 1-3, with the foot platform rotated forward;

FIG. 5 is a perspective view of a pivot assembly of the foot pedal from FIGS. 1-4;

FIG. 6 is a perspective view of an outer sheath of the pivot assembly from FIG. 5;

FIG. 7 is a perspective view of a first side of an inner axle assembly of the pivot assembly from FIG. 5;

FIG. 8 is another perspective view of a second side of the inner axle assembly from FIG. 7;

FIG. 9 is a top plan view of the pivot assembly from FIG. 5;

FIG. 10 is a cross-section of the pivot assembly taken along the line 10—10 from FIG. 9;

FIG. 11 is a cross-section of the pivot assembly taken along the line 11—11 from FIG. 9;

FIG. 12 is a cross-section of the pivot assembly taken along the line 12—12 from FIG. 9;

FIG. 13 is an exploded view of the pivot assembly from FIG. 5;

FIG. 14 is a perspective view of the pivot assembly from FIG. 5, with connecting ears at ends of the pivot assembly removed;

FIG. 15 is an exploded view of the pivot assembly from FIG. 14;

FIG. 16 is a plan view of the pivot assembly from FIG. 15, with an axle set apart from remaining components of the pivot assembly;

FIG. 17 is a perspective view of an outer friction ring of the pivot assembly from FIG. 5;

FIG. 18 is a perspective view of an inner friction ring of the pivot assembly from FIG. 5;

FIG. 19 is a perspective view of the inner friction ring from FIG. 18 being at least partially received within the outer friction ring of FIG. 17;

FIG. 20 is a perspective view of an outer sheath of another pivot assembly for a foot pedal according to embodiments of the present invention;

FIG. 21 is a perspective view of an inner cylinder configured to be operably engaged within the outer sheath from FIG. 20; and

FIG. 22 is a partial cross-section of the inner cylinder from FIG. 21, illustrating a ring being rotatable with respect to a sleeve of the inner cylinder.

The figures are not intended to limit the present invention to the specific embodiments they depict. While the drawings do not necessarily provide exact dimensions or tolerances for the illustrated structures or components, the drawings are to scale with respect to the relationships between the components of the structures illustrated in the drawings.

### DETAILED DESCRIPTION

The following detailed description of embodiments of the invention references the accompanying figures. The embodiments are intended to describe aspects of the invention in sufficient detail to enable those with ordinary skill in the art to practice the invention. The embodiments of the invention are illustrated by way of example and not by way of limitation. Other embodiments may be utilized and changes may be made without departing from the scope of the claims. The following description is, therefore, not limiting. The scope of the present invention is defined only by the appended claims, along with the full scope of equivalents to which such claims are entitled.

In this description, references to “one embodiment,” “an embodiment,” or “embodiments” mean that the feature or features referred to are included in at least one embodiment of the invention. Separate references to “one embodiment,” “an embodiment,” or “embodiments” in this description do not necessarily refer to the same embodiment and are not mutually exclusive unless so stated. Specifically, a feature, component, action, step, etc. described in one embodiment may also be included in other embodiments, but is not necessarily included. Thus, particular implementations of the present invention can include a variety of combinations and/or integrations of the embodiments described herein.

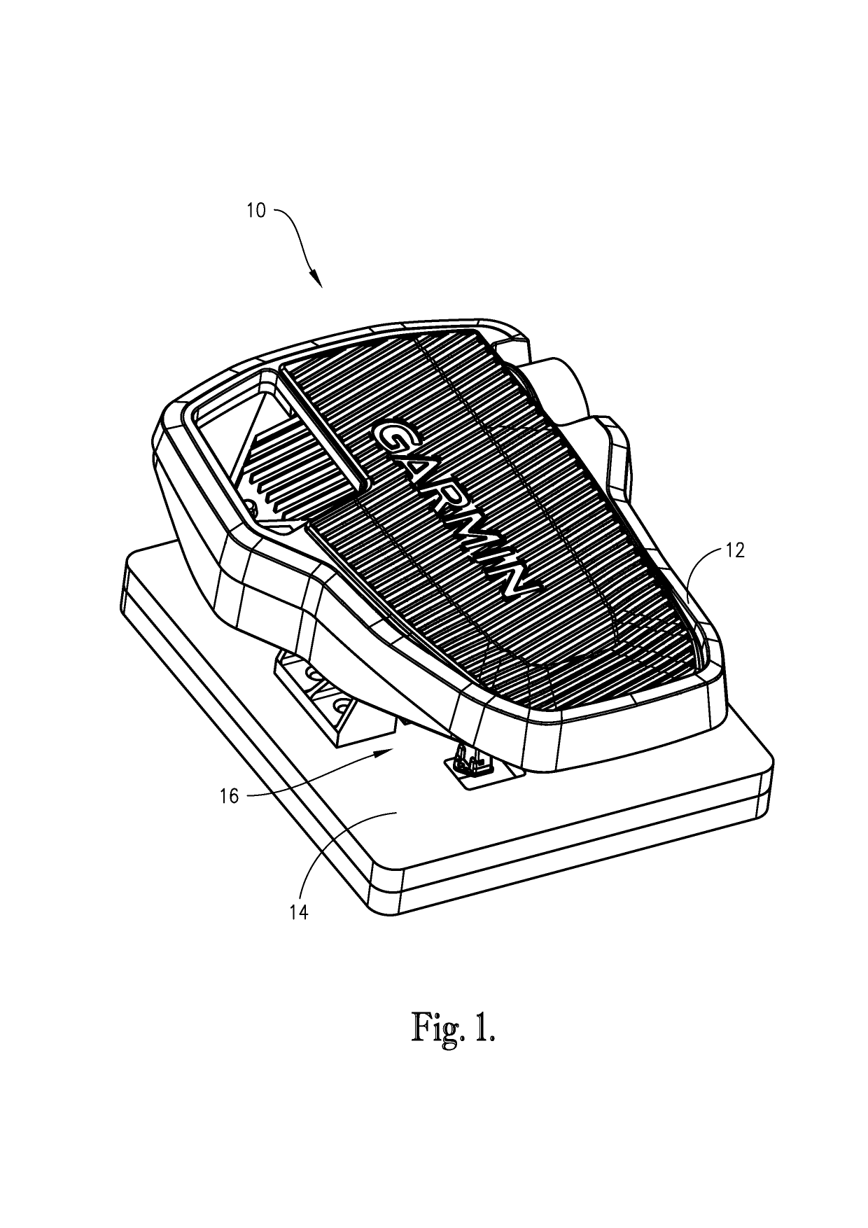

Embodiments of the present invention are directed to foot pedal 10 for a trolling motor, as illustrated in FIGS. 1-4. The foot pedal 10 may comprise many of the elements and/or functionalities as the foot pedal described in commonly-assigned U.S. Patent No. 10,884,416, the entirety of which is incorporated herein by reference. In addition, though, the foot pedal 10 according to embodiments of the present invention may comprise a pivot assembly, as described in more detail below, which allows the foot pedal 10 to be configured with various levels of rotational resistance or damping. As such, the foot pedal 10 is configured to provide a controlled level of resistance against the pivoting movement of the foot pedal 10 during operation by a user, thereby enhancing operational consistency and stability of the foot pedal 10 and the associated trolling motor or other system being controlled by the foot pedal 10.

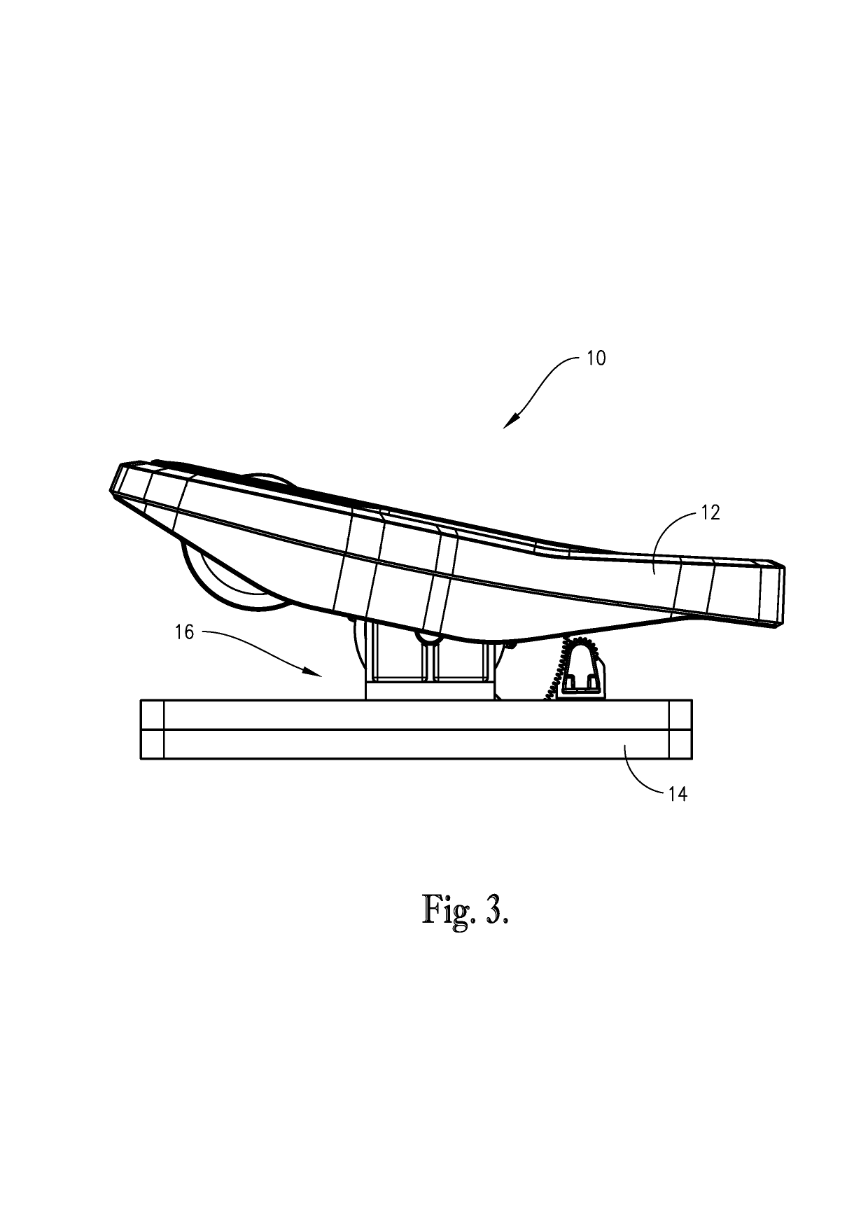

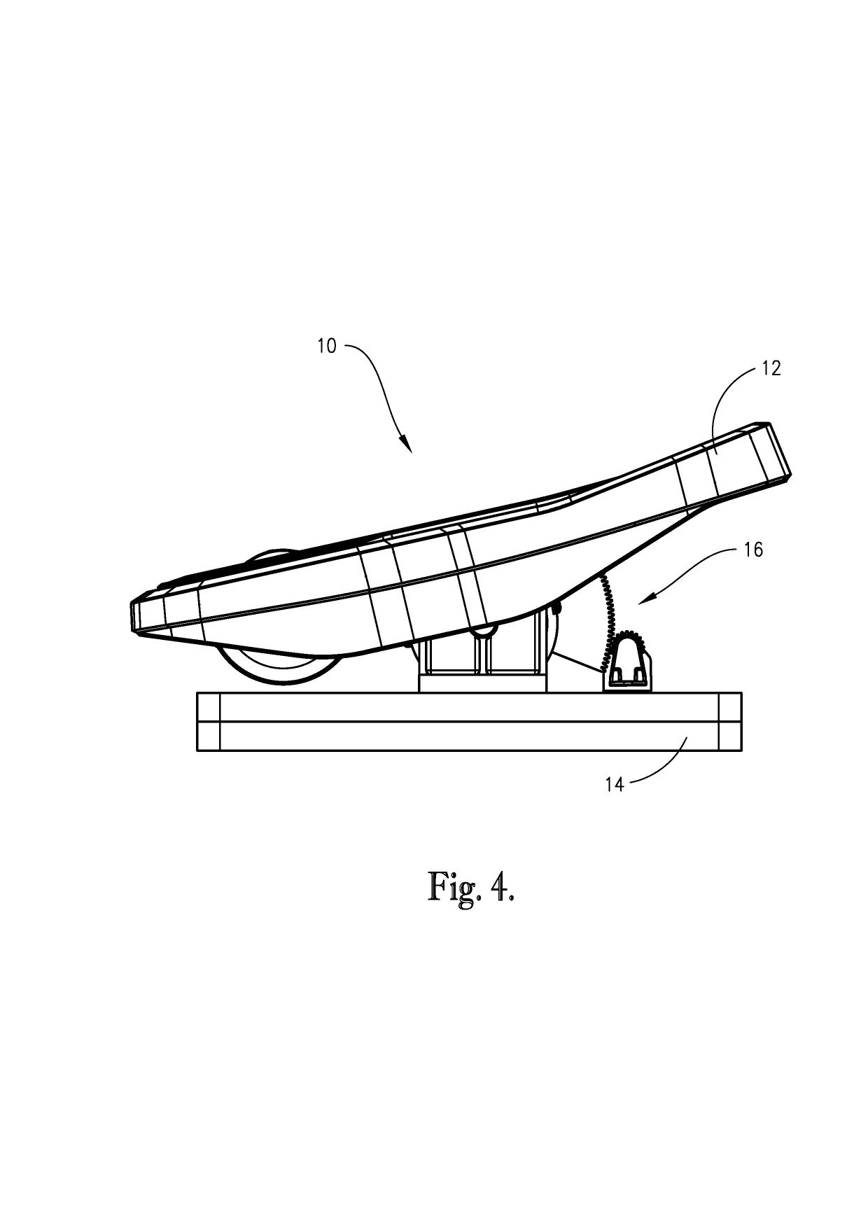

In more detail, the foot pedal 10 illustrated in FIGS. 1-4 is configured to generate control signals for steering and/or speed control of a trolling motor (not shown) based on user input comprised of the pivotal movement of a foot platform 12 of the foot pedal 10. The foot pedal 10 can include a base 14 that is configured to support the foot pedal 10 on a surface, such as a deck of a fishing vessel (not shown). The foot platform 12 is pivotably connected to the base 14 via a pivot assembly 16, such that the foot platform 12 can pivot or rotate (e.g., in response to actuation by a foot of the user of the foot pedal 10) with respect to the base 14 about the pivot assembly 16. FIG. 4 illustrates the foot platform 12 rotated forward, while FIG. 3 illustrates the foot platform 12 rotated rearward. Notably, as will be described in detail below, the pivot assembly 16 is configured to apply an adjustable damping force against rotation of the foot platform 12, to provide a controlled level of resistance against the pivoting movement of the foot platform 12 during operation by a user.

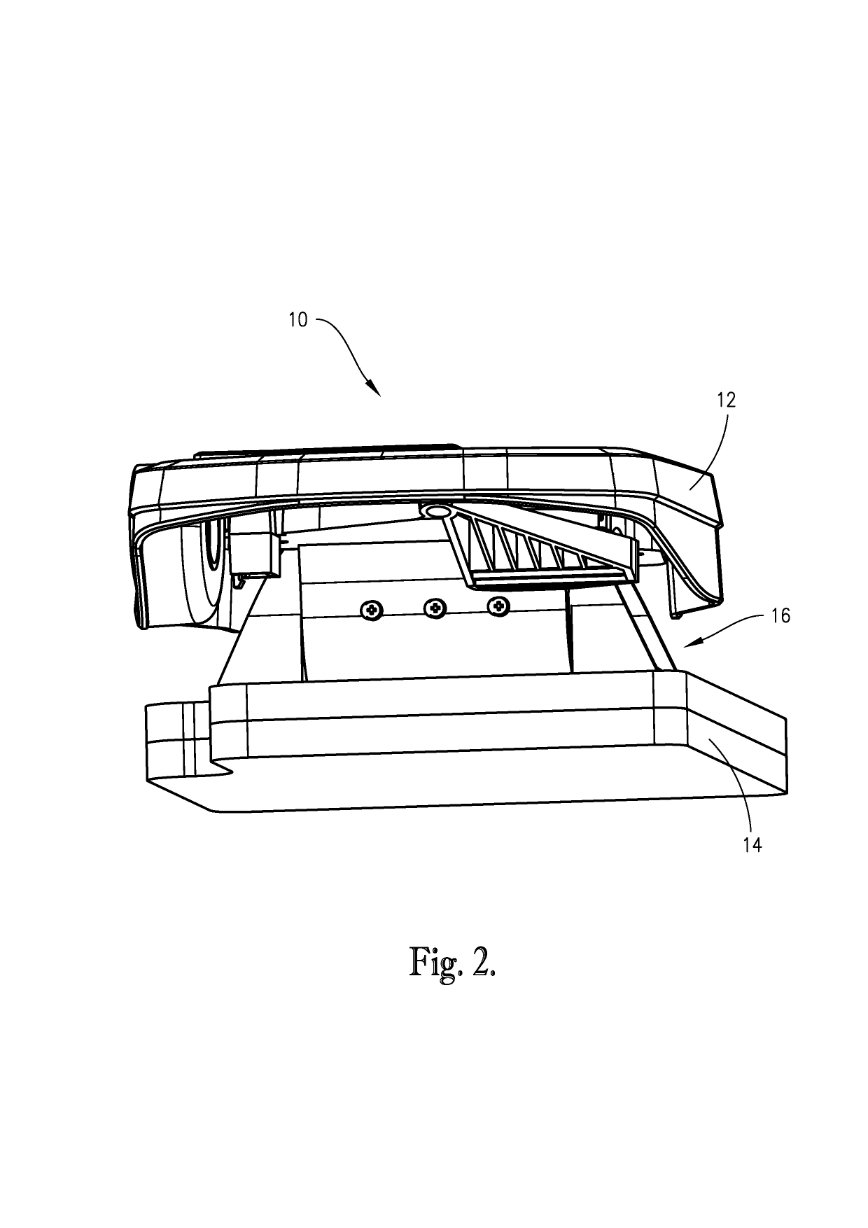

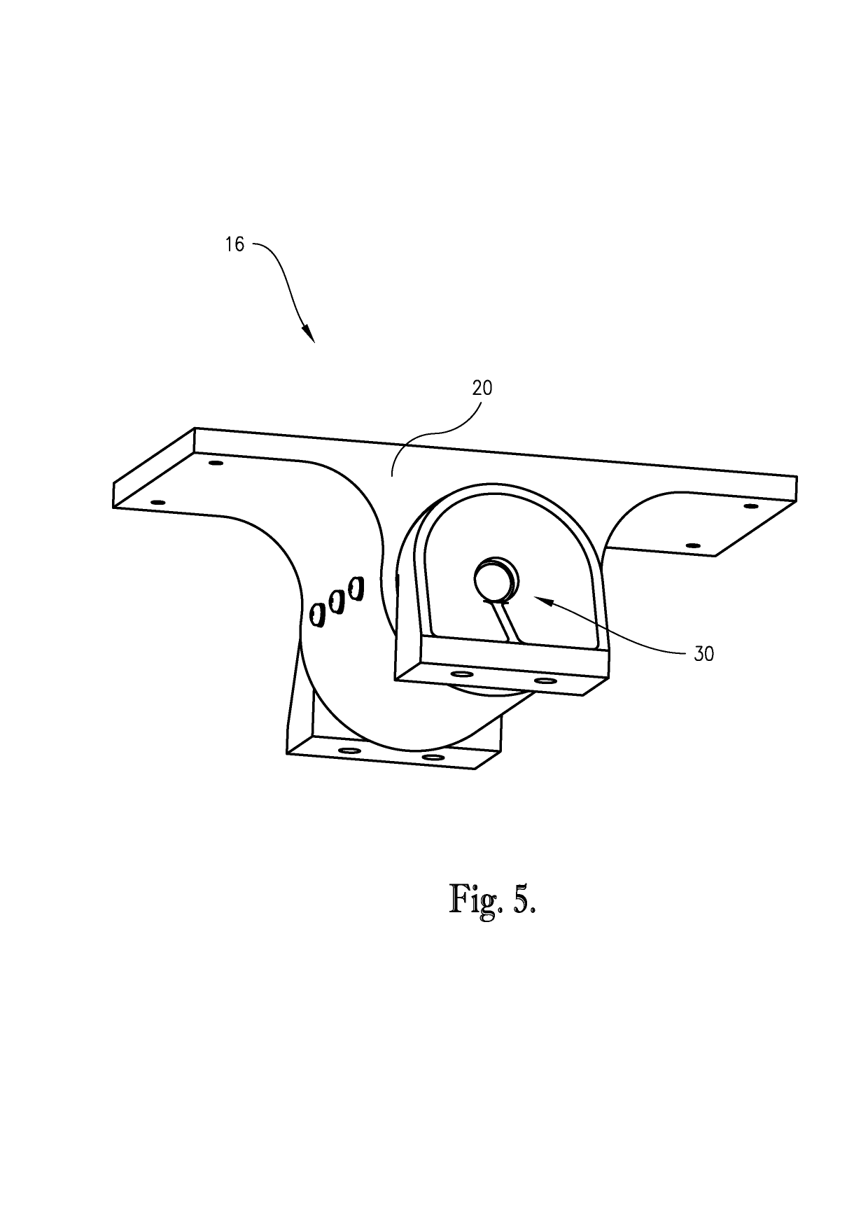

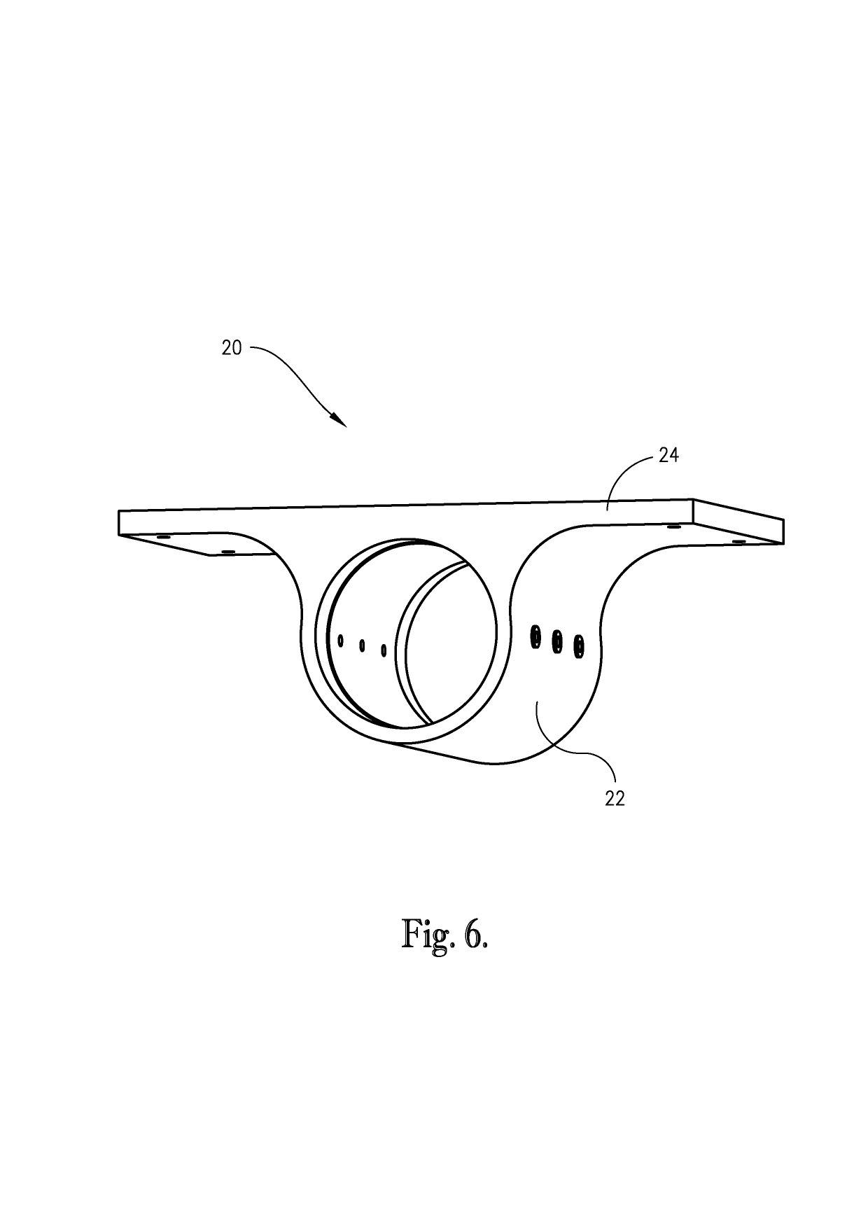

In more detail, as illustrated in FIG. 5, the pivot assembly 16 may comprise an outer sheath 20. Turning to FIG. 6, the outer sheath 20 may comprise a hollow cylindrical main body 22 and a mounting plate 24. The mounting plate 24 includes a mounting surface configured to be rigidly secured to a bottom of the foot platform 12 (see FIG. 2). Returning to FIG. 5, the pivot assembly 16 further includes an inner axle assembly 30 configured to be generally received within the hollow cylindrical space of the main body 22 of the outer sheath 20 (see the hollow cylindrical space in FIG. 6). The inner axle assembly 30 and the outer sheath 20 are configured to rotate with respect to each other. Furthermore, as shown in FIGS. 7 and 8, each end of the inner axle assembly 30 may be rigidly attached to a connecting ear 32, with such connecting ears 32 being rigidly secured to a top of the base 14 (see FIGS. 1-4). As such, the foot platform 12 and the outer sheath 20 are configured to rotate with respect to the inner axle assembly 30, the connecting ears 32, and the base 14.

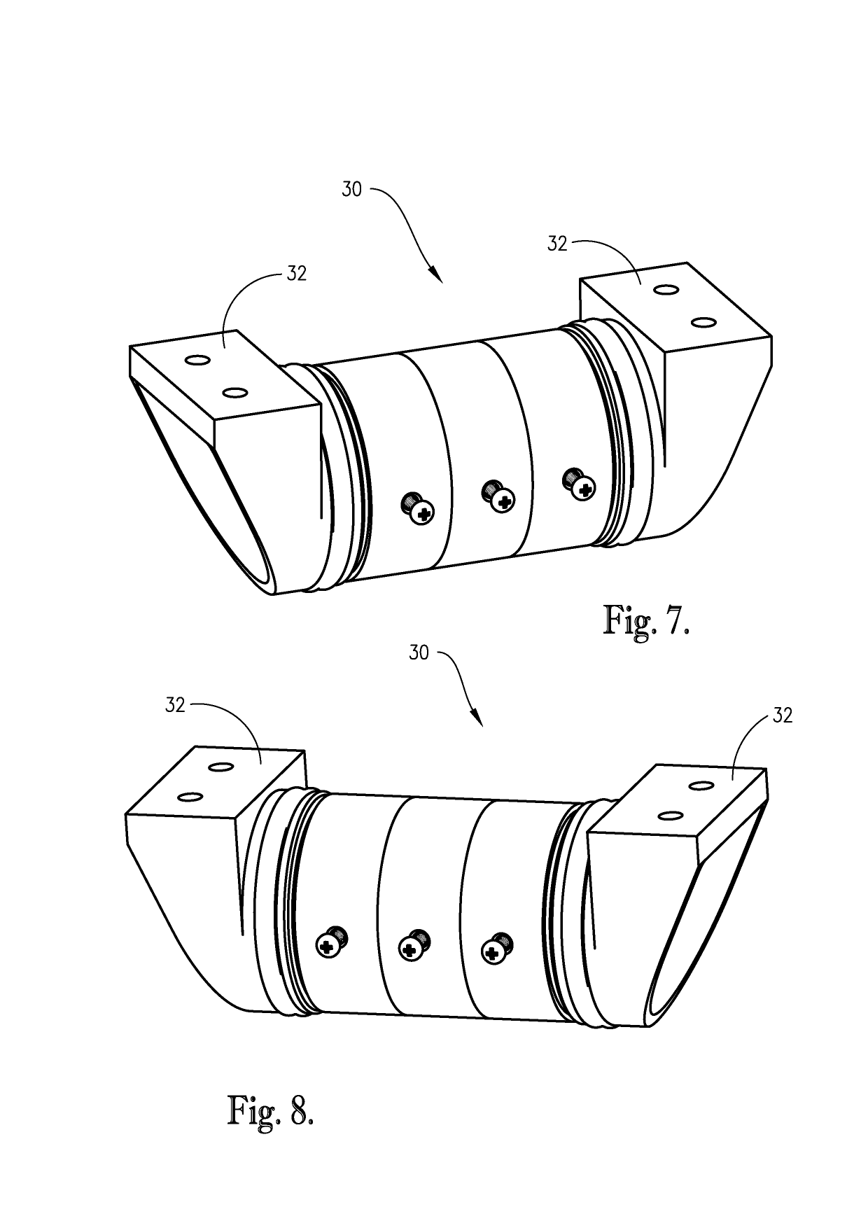

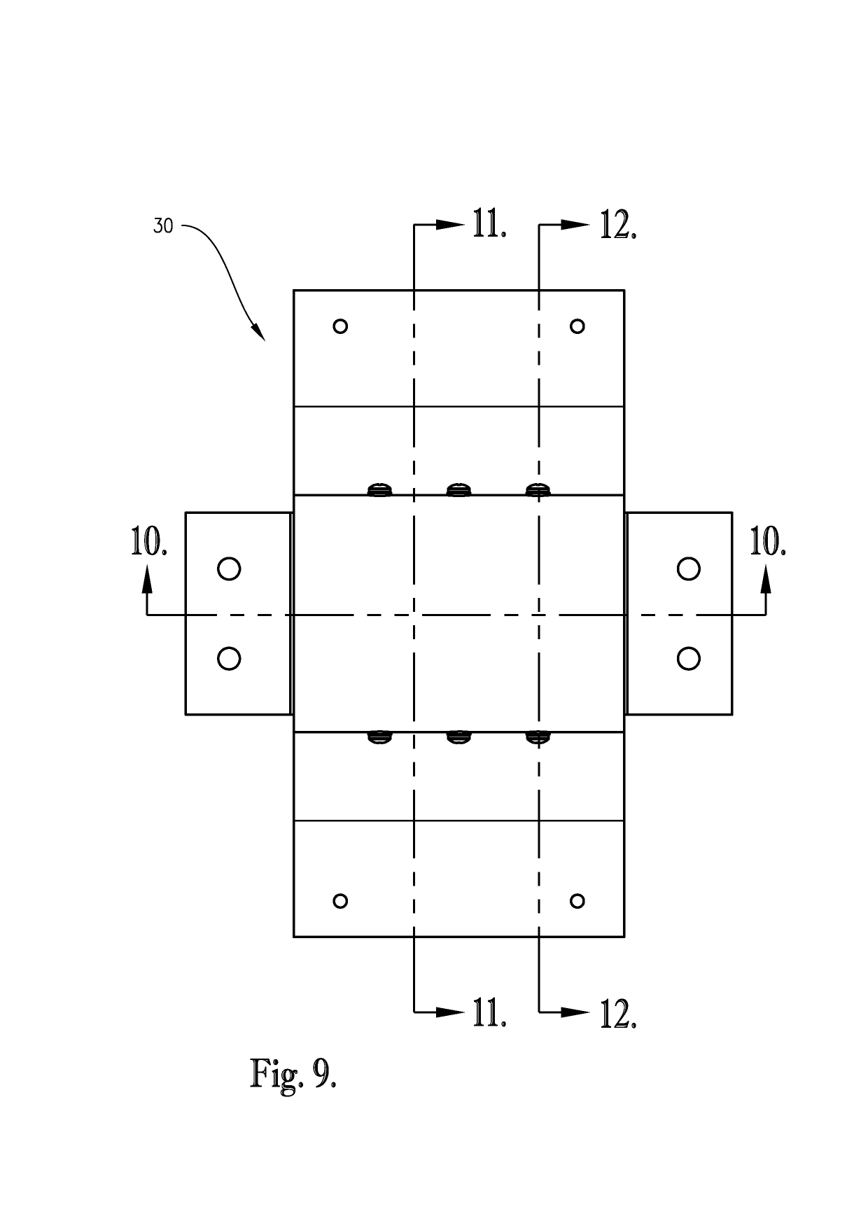

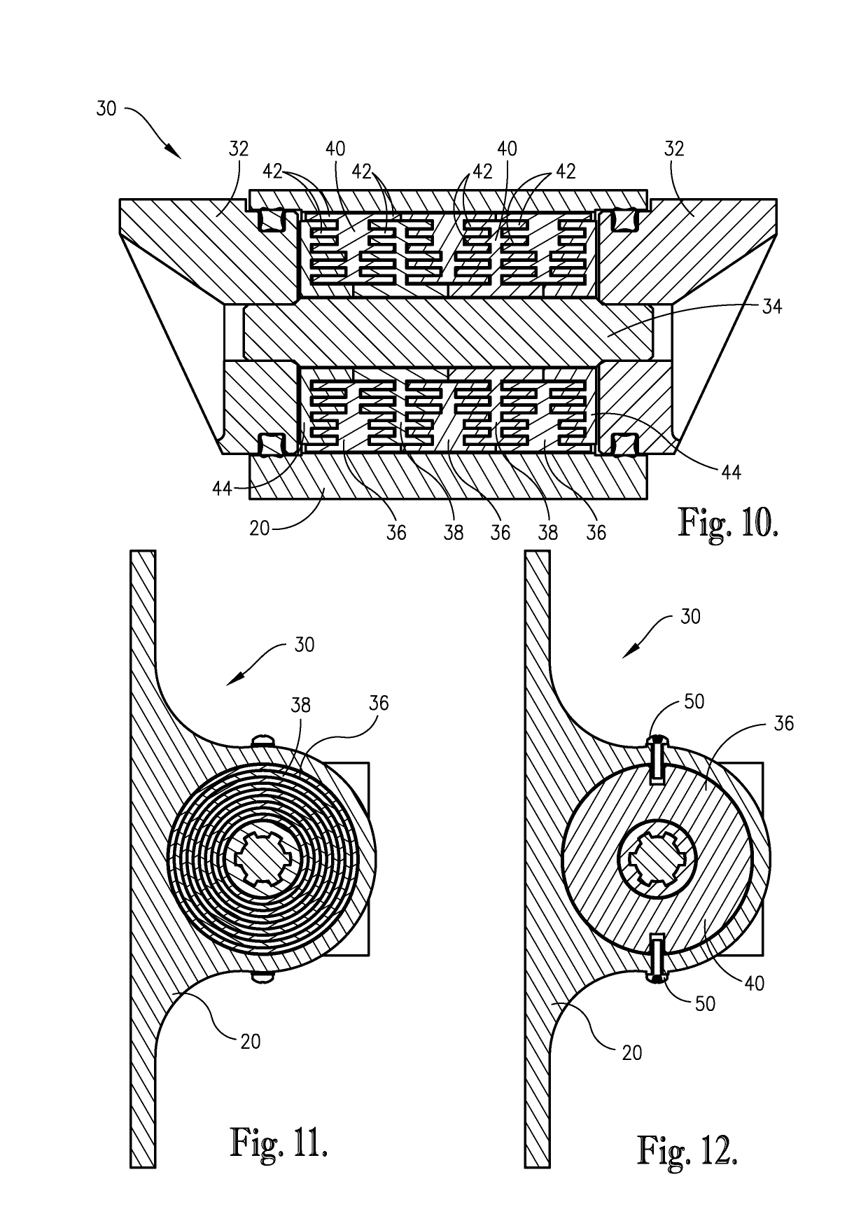

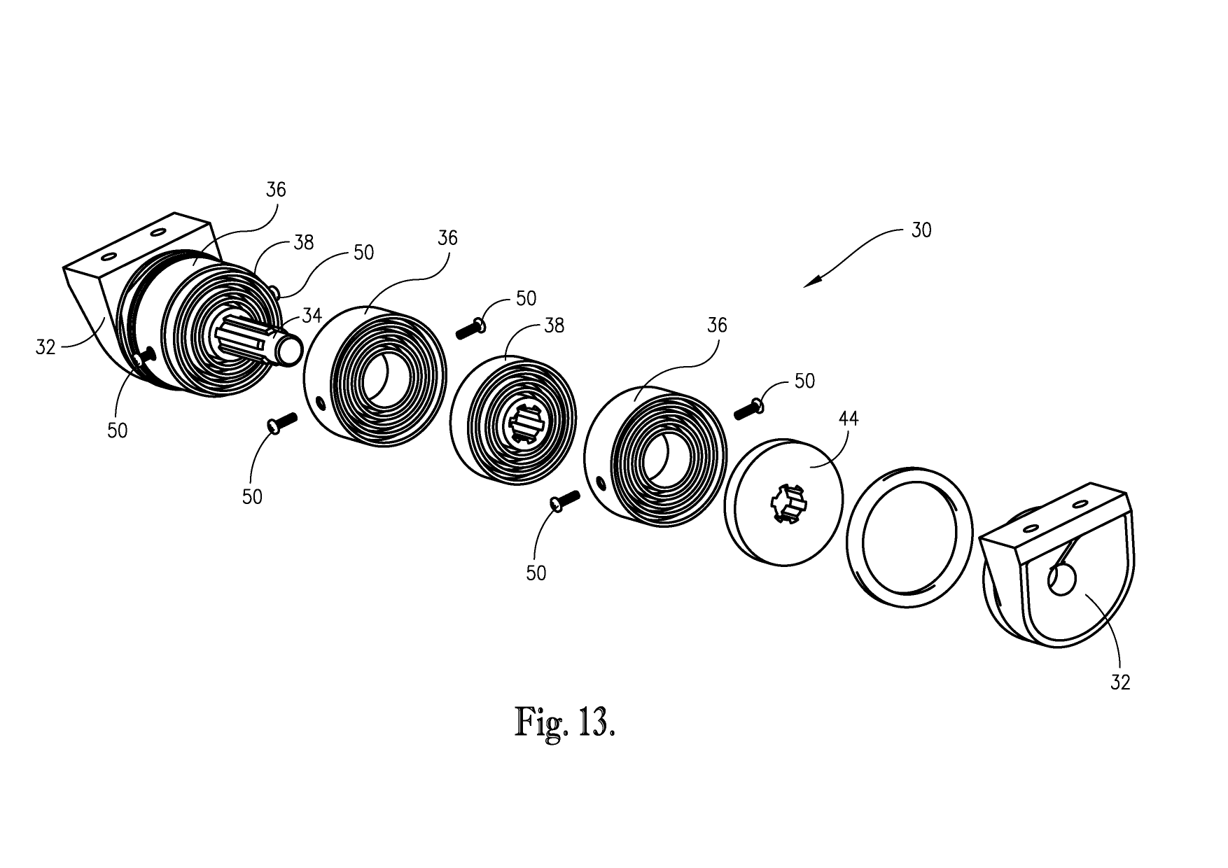

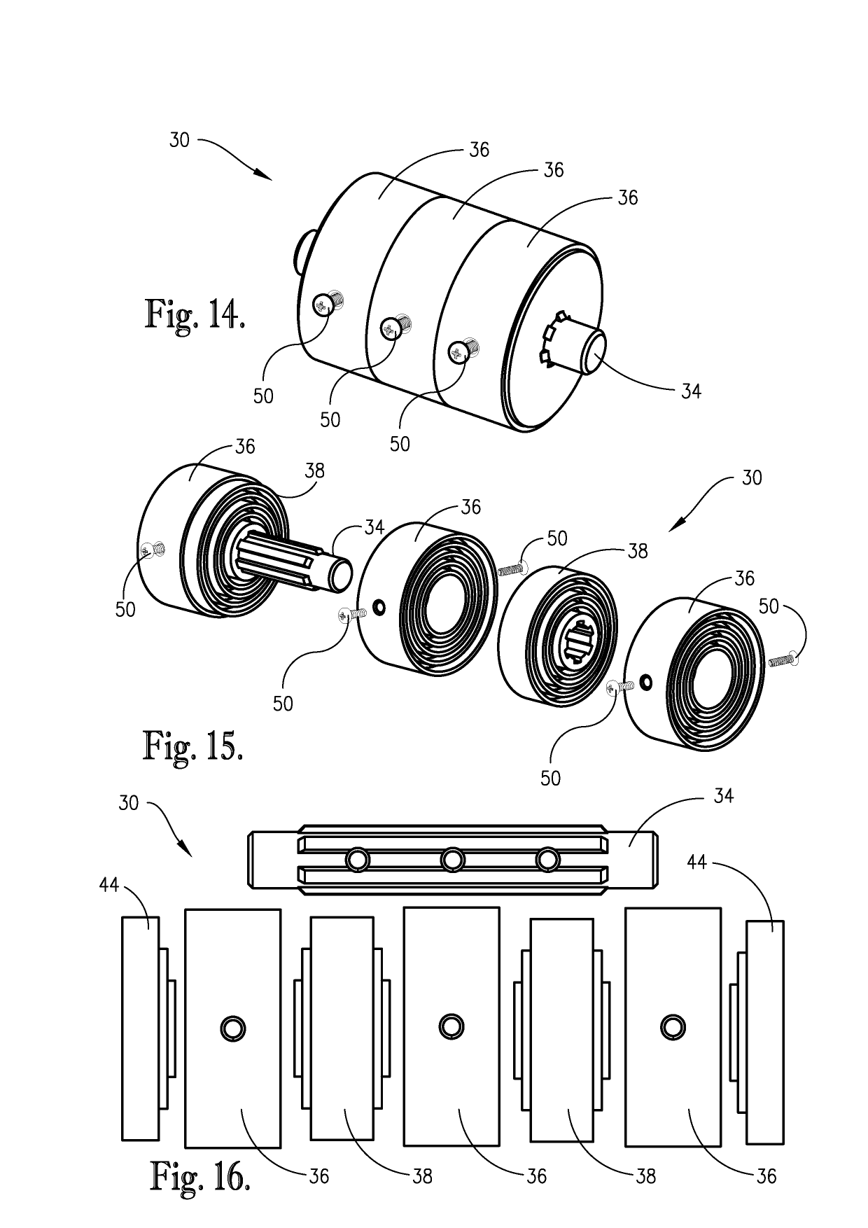

Turning to the inner axle assembly 30 in more detail, FIG. 9 illustrates a top plan view of the inner axle assembly 30, while FIGS. 10-12 illustrate various cross sections of the inner axle assembly 30. As shown in FIGS. 13-16, the inner axle assembly 30 may comprise an axle 34, at least one outer friction ring 36, and at least one inner friction ring 38 (the inner friction rings 38 are not shown in FIG. 14). As illustrated in FIG. 10, the axle 34 may comprise an elongated rod with ends rigidly coupled with the connecting ears 32. As shown in FIGS. 13, 15, and 16, the axle 34 may include ridges or protrusions that extend along a significant portion of a length of the axle 34. In certain embodiments, the inner axle assembly 30 may include a plurality of outer friction rings 36 and a plurality of inner friction rings 38. For example, as illustrated in FIGS. 13-16, the inner axle assembly 30 may include three outer friction rings 36 and two inner friction rings 38. In some embodiments, the inner axle assembly 30 may include “n” (any whole number) of outer friction rings 36 and “n-1” inner friction rings 38.

As illustrated in FIGS. 13 and 15, each of the outer and inner friction rings 36, 38 may include a central opening through a center of the friction rings 36, 38, such that the friction rings 36, 38 can be mounted on the axle 34. In particular, an interior surface of each of the inner friction rings 38, which defines the inner friction ring’s 38 central opening, may include notches configured to be engaged with the ridges or protrusions that extend along the outer surface of the axle 34. As such, when the inner friction rings 38 are mounted on the axle 34, movement of the inner friction rings 38 with respect to the axle 34 is restricted. In contrast, an interior surface of each of the outer friction rings 36, which defines the outer friction ring’s 36 central opening, may not include notches that can engage with the ridges or protrusions of the axle 34. As such, when the outer friction rings 36 are mounted on the axle 34, movement of the outer friction rings 36 with respect to the axle 34 is not restricted by the axle 34.

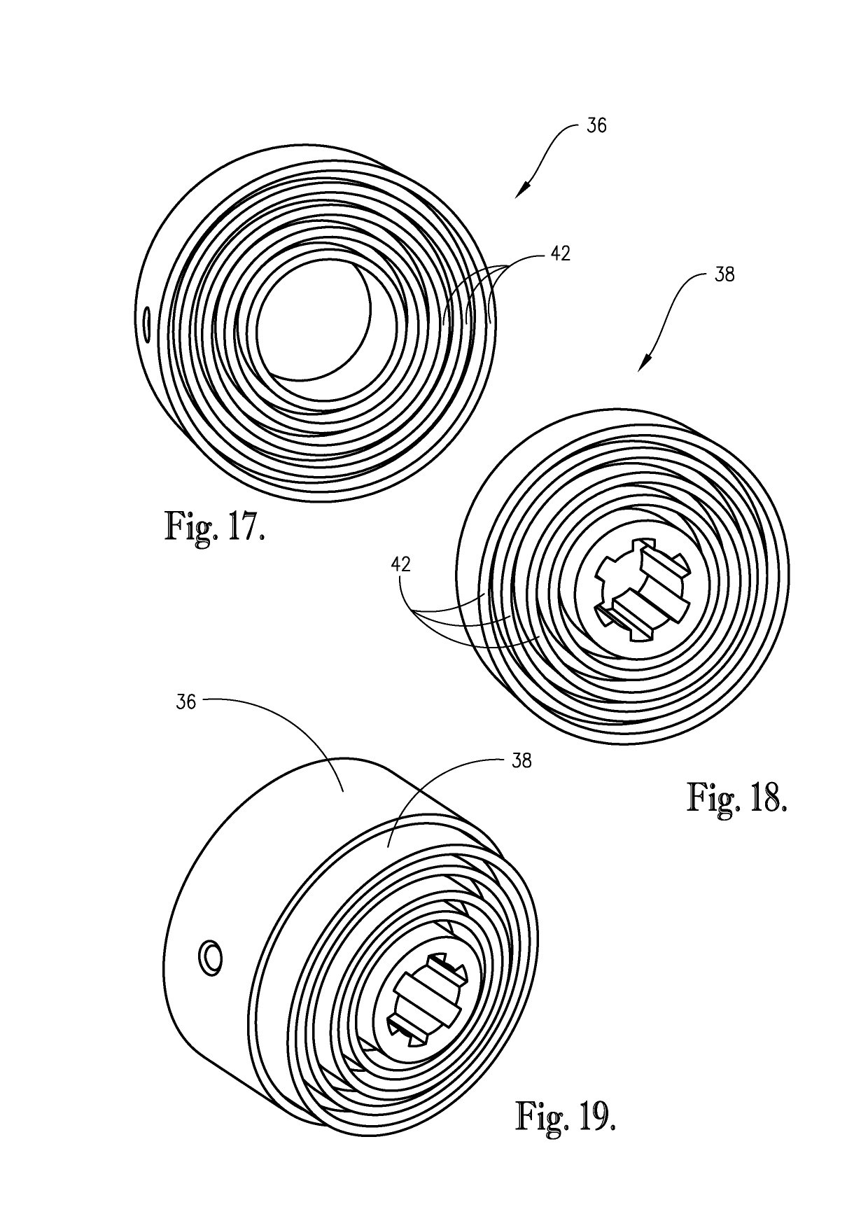

As perhaps best illustrated in FIG. 10, each of the outer and inner friction rings 36, 38 may comprise a central, main plate 40 having a generally circular shape. When the outer and inner friction rings 36, 38 are mounted on the axle 34, the main plates 40 of the friction rings 36, 38 are generally orthogonal to the axle 34 (or orthogonal to a longitudinal axis of the axle 34). In addition, each of the outer and inner friction rings 36, 38 may further comprise a plurality of annular fins 42 that extend laterally outward from both sides of the respective main plate 40. When the outer and inner friction rings 36, 38 are mounted on the axle 34, the axle 34 (or a longitudinal axis of the axle 34) forms a center of the annular fins 42. The annular fins 42 extending from one side of a main plate 40 may share a common center (which may be the center of the central opening of the respective outer or inner friction ring 36, 38) and may be radially spaced apart from each other, such that a space or gap is present between adjacent annular fins 42. The annular fins 42 and the space therebetween are illustrated in more detail in FIGS. 17 and 18. As a result of the configuration of spaced apart annular fins 42, the inner friction rings 38 can engage with and partially fit within the outer friction rings 36, as illustrated in FIGS. 11 and 19.

In more detail, the inner friction rings 38 are generally sized smaller than the outer friction rings 36. Specifically, outermost annular fins 42 of the outer friction rings 36 have a larger diameter than outermost annular fins 42 of the inner friction rings 38. The diameters of the remaining annular fins 42 of the inner friction rings 38 are also different from the remaining annular fins 42 of the outer friction rings 36. As such, the annular fins 42 on one side of a given inner friction ring 38 can fit within the space between adjacent annular fins 42 on one side of a first outer friction ring 36. In addition, the annular fins 42 on the opposite side of the given inner friction ring 38 can fit within the space between adjacent annular fins 42 on one side of a second outer friction ring 36. As a result, the given inner friction ring 38 can be positioned entirely within the outer friction rings 36, as illustrated by FIGS. 10 and 13.

In addition to the above, the inner axle assembly 30 may include a pair of end caps 44, as illustrated in FIGS. 10 and 16. Each end cap may similarly comprise a circular main plate similar to the main plates 40 of the outer or inner friction ring 36, 38. In addition, each end cap 44 may include annular fins that are sized and/or configured similar to the annular fins 42 of the inner friction rings 38. However, in contrast to the inner friction rings 38, the annular fins of each end cap 44 may extend from only one side of the end cap’s 44 main plate. The opposite side of the main plate of the end cap 44 may be generally flat. As such, the sides of the end caps 44 with annular rings can be received within one side of a given outer friction ring 36, similar to how the inner friction rings 38 are at least partly received within the outer friction rings 36. The opposite, flat side of each end cap 44 may be secured to one of the connecting ears 32.

The above-described components of the inner axle assembly 30 may, thus, be operatively configured as follows. As shown in FIG. 10, a first end cap 44 may be secured to a first of the connecting ears 32, with the axle 34 extending through a central opening of the first end cap 44. As illustrated in FIGS. 10, 13, 15, and 16, a first outer friction ring 36 may be mounted on the axle 34, with the annular fins of the first end cap 44 being received within the spaces between the annular fins 42 on a first side of the first outer friction ring 36. In addition, a first inner friction ring 38 may be mounted on the axle 34, with the annular fins 42 on a first side of the first inner friction ring 38 being received within the spaces between the annular fins 42 on a second side of the first outer friction ring 36. A second outer friction ring 36 may be mounted on the axle 34, with the annular fins 42 on a second side of the first inner friction ring 38 being received within the spaces between the annular fins 42 on a first side of the second outer friction ring 36. As a result, the first inner friction ring 38 is entirely received within and enclosed by the first and second outer friction rings 36. A second inner friction ring 38 and a third outer friction ring 36 may be similar mounted on the axle 34, with the second inner friction ring 38 being entirely received within and enclosed by the second and third outer friction rings 36. A second end cap 44 may be secured to a second of the connecting ears 32, with the axle 34 extending through a central opening of the second end cap 44. The annular fins of the second end cap 44 are received within the space between the annular fins 42 on a side of the third outer friction ring 36 (the side opposite the second inner friction ring 38). As such, the first and second inner friction rings 38 are completely received within and/or enclosed by the first, second, and third outer friction rings 36, as shown in FIGS. 7, 8, 10, and 14.

The outer friction rings 36 are configured to rotate with respect to the inner friction rings 38 and/or the end caps 44. Specifically, the annular fins 42 of the inner friction rings 38 and/or the end caps 44 are configured to fit within the spaces between the annular fins 42 of the outer friction rings 36 such that surface contact is made between the annular fins 42 of the inner friction rings 38 and/or the end caps 44 and the annular fins 42 of the outer friction rings 36. As such, surface contact between the outer friction rings 36 and the inner friction rings 38 and/or the end caps 44 is increased to provide a predefined amount of frictional force that can resist relative rotation between the outer friction rings 36 and the inner friction rings 38 and/or the end caps 44. The predefined amount of frictional force can vary based on the materials of which the outer friction rings 36 and the inner friction rings 38 and/or the end caps 44 are formed.

For example, in some embodiments, the outer friction rings 36 and the inner friction rings 38 and/or the end caps 44 (or at least their annular fins 42) may be formed from metals, polymers, or composite. Metals can offer durability and consistent friction levels, while polymers or composites may reduce weight and allow for molded geometries that simplify assembly. For example, the inner axle assembly 30 may be constructed from materials that provide smooth rotational surfaces, such as low-friction polymers or lubricated metals. In some configurations, materials with varying hardness or surface treatments, such as anodizing or PTFE coatings, can be applied to the components of the inner axle assembly 30 to optimize frictional resistance while minimizing wear.

Lubricants may be selectively applied to certain components of the pivot assembly 16 to further control frictional resistance and facilitate smoother transitions between resistance levels. For instance, a light grease or silicone-based lubricant may be introduced between the inner axle assembly 30 and the outer sheath 20 to decrease or manage friction. Likewise, grease or lubricants may be positioned between the outer friction rings 36 and the inner friction rings 38 and/or the end caps 44 (or at least their annular fins 42) to provide a desired amount of friction.

To provide adjustable levels of rotational resistance or damping, the pivot assembly 16 may include at least one retaining mechanism 50, as illustrated in FIGS. 13-15, configured to selectively restrict rotation of at least one outer friction ring 36 with respect to the outer sheath 20. In some embodiments, the pivot assembly 16 may include one retaining mechanism 50 for each outer friction ring 36. In other embodiments, the pivot assembly 16 may include a pair of retaining mechanisms 50 for each outer friction ring 36. In some embodiments, the retaining mechanisms 50 may comprise set screws configured to be inserted through through-holes formed in the outer sheath 20 (see, e.g., FIG. 6) and into engagement with the outer friction rings 36 (see, e.g., FIGS. 13-15). FIG. 13 illustrates each of the outer friction rings 36 including notches within which ends of the set screws can be received. FIG. 12 illustrates a pair of set screws inserted through the outer sheath 20 and into engagement with an outer friction ring 36 (i.e., into notches formed in central main plate 40). When the set screws are inserted through the outer sheath 20 and into engagement with the outer friction ring 36, relative rotation between the outer sheath 20 and the outer friction ring 36 is restricted. As will be described in more detail below, the adjustable levels of rotational resistance or damping can be controlled by selecting the number of outer friction rings 36 held in place with respect to the outer sheath 20 via retaining mechanisms 50.

For instance, when no retaining mechanisms 50 are used to restrict rotation between the outer sheath 20 and the outer friction ring 36, the pivot assembly 16 will provide the least amount of rotational resistance or damping with respect to rotation of the foot platform 12 of the foot pedal 10. As such, when the foot platform 12 is rotated from a rearward position (e.g., FIG. 3) to a forward position (e.g., FIG. 4), the outer sheath 20 will generally rotate freely around the inner axle assembly 30 with the least amount of rotational resistance or damping. To increase the rotational resistance or damping experienced during rotation of the foot platform 12, one or more retaining mechanisms 50 can be inserted through the outer sheath 20 to engage with one or more of the outer friction rings 36 to restrict relative movement between the outer sheath 20 and the outer friction rings 36. For example, with reference to FIG. 10, if a retaining mechanism 50 (not shown in FIG. 10 but see FIG. 12) is used to restrict rotation of a first outer friction ring 36 (e.g., the left-most outer friction ring 36) with respect to the outer sheath 20, when the foot platform 12 is rotated from a rearward position to a forward position, the outer sheath 20 can no longer freely rotate around the inner axle assembly 30. Instead, the first outer friction ring 36 will rotate along with the outer sheath 20 (due to the retaining mechanism 50). Rotation of the first outer friction ring 36 will experience rotational resistance or damping due to the friction between the annular fins 42 of the first outer friction ring 36 and the annular fins 42 of a first inner friction ring 38 and/or a first end cap 44. Such friction causes a rotational resistance or damping as the first outer friction ring 36 rotates (in conjunction with the outer sheath 20) with respect to the first inner friction ring 38 and/or the first end cap 44.

Thus, when one or more retaining mechanisms 50 are used to restrict relative rotation between the outer sheath 20 and one of the outer friction rings 36, rotational resistance or damping of rotation of the foot platform 12 is increased over the situation initially described when no retaining mechanisms 50 are used to restrict rotation between the outer sheath 20 and any of the outer friction rings 36. To increase rotational resistance or damping even further, a second outer friction ring 36 (e.g., the center outer friction ring 36 of FIG. 10) may also be secured to the outer sheath 20 via one or more retaining mechanisms 50, such that the outer sheath 20 is restricted from rotating with respect to two outer friction rings 36. As a result, those two outer friction rings 36 will both experience rotational resistance or damping due to the friction between the annular fins 42 of the two outer friction rings 36 and the annular fins 42 of at least a portion of two inner friction rings 38 and/or the first end cap 44.

To increase rotational resistance or damping still further, a third outer friction ring 36 (e.g., the right-most outer friction ring 36 of FIG. 10) may also be secured to the outer sheath 20 via one or more retaining mechanisms 50, such that the outer sheath 20 is restricted from rotating with respect to three outer friction rings 36. As a result, those three outer friction rings 36 will all experience rotational resistance or damping due to the friction between the annular fins 42 of the three outer friction rings 36 and the annular fins 42 of the two inner friction rings 38 and/or the two end caps 44. Restricting rotation between the outer sheath 20 and three outer friction rings 36 may provide the maximum amount of rotational resistance or damping for rotation of the foot platform 12. Thus, a user of the foot pedal 10 may adjust the rotational resistance or damping provided by the pivot assembly 16 to a preferred rotational resistance or damping by using a preferred number of retaining mechanisms 50 to restrict relative rotation between the outer sheath 20 and a preferred number of outer friction rings 36. It should be understood that although the figures illustrate a pivot assembly 16 with three outer friction rings 36, embodiments of the present invention may provide for more outer and/or inner friction rings 36, 38 to be included to increase a maximum rotational resistance or damping and/or to provide additional adjustability to the rotational resistance or damping of the foot pedal 10.

An exemplary method of adjusting a rotational damping force of a trolling motor foot pedal 10 is provided. The method may comprise a step of rotationally supporting, via a pivot assembly 16, a foot platform 12 with respect to a base 14. The pivot assembly 16 may comprise an outer sheath 20 and an inner axle assembly 30. The outer sheath 20 and at least a portion of the inner axle assembly 30 are configured to relatively rotate with respect to each other. The inner axle assembly 30 comprises an axle 34, at least one outer friction ring 36, and at least one inner friction ring 38. The inner friction ring 38 is configured to selectively rotate with respect to the outer friction ring 36. An additional step includes rotating the foot platform 12 with respect to the base 14, with the pivot assembly 16 being configured to impart a first damping force against rotation of the foot platform 12. An additional step includes engaging at least one retaining mechanism 50 between the outer friction ring 36 and the outer sheath 20. After the engaging step, a further step includes rotating the foot platform 12 with respect to the base 14, with the pivot assembly 16 being configured to impart a second damping force against rotation of the foot platform 12. The second damping force is different than the first damping force. And, in some embodiments, the second damping force is greater than the first damping force.

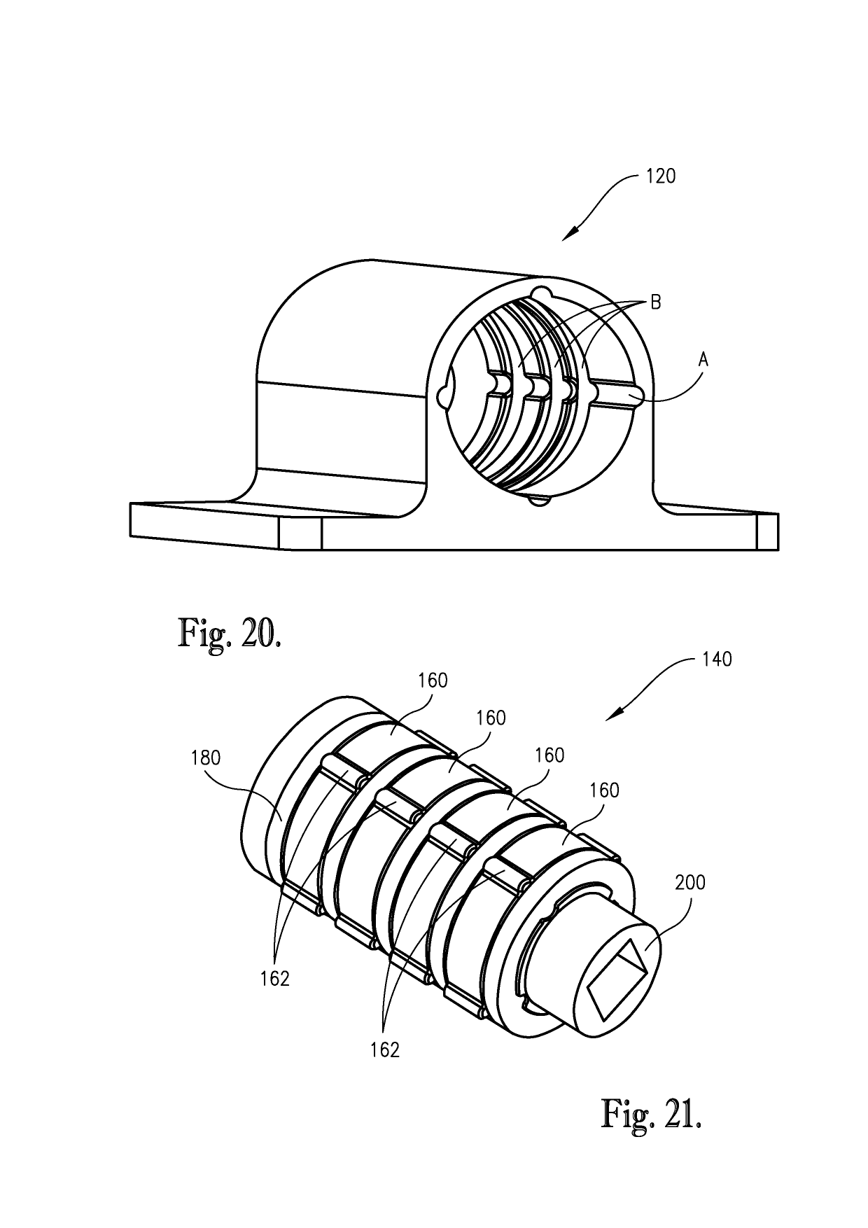

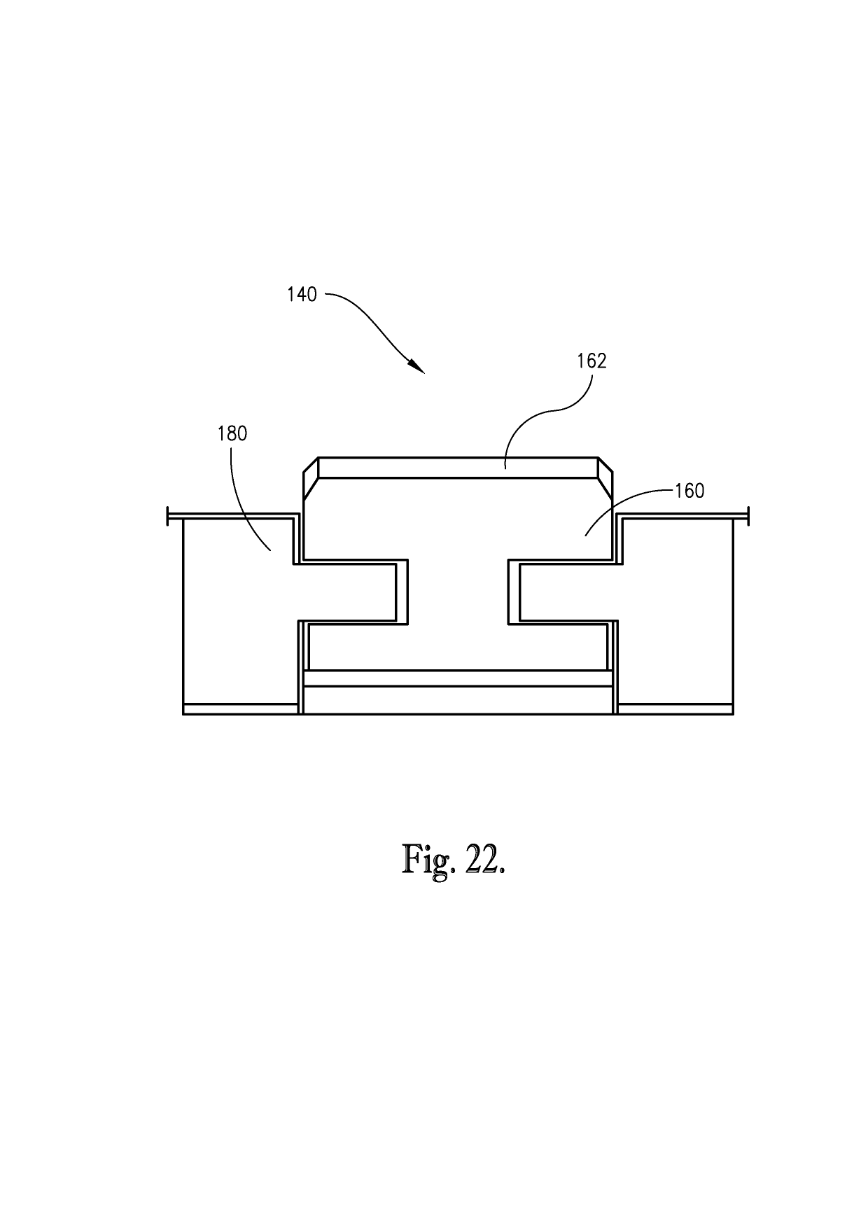

As such, the foot pedal 10 of embodiments of the present invention provides an improved rotary damper that may be quickly and efficiently adjusted by users to create variable resistance while providing a small and compact footprint for integration with a foot pedal control system for a trolling motor of a water vessel. An additional embodiment of a foot pedal according to the present invention is described below, with reference to FIGS. 20-22.

As shown in FIGS. 20 and 21, the foot pedal according to additional embodiments of the present invention may include a pivot assembly that generally includes an outer sheath 120 and a rotatable inner cylinder 140. The inner cylinder 140 can be caused to rotate with respect to the outer sheath 120 by part of the foot pedal (e.g., the foot platform that is not shown) rotating with respect to the base (also not shown) of the foot pedal. Friction between the inner cylinder 140 and outer sheath 120 resists movement of the foot platform with respect to the base, ensuring that the foot platform can be accurately positioned by the user, and remain in position, to control a trolling motor or other system associated with the foot pedal.

The inner circumferential surface of the outer sheath 120 includes one or more longitudinal grooves A and one or more circumferential grooves B that may be generally perpendicular to the longitudinal grooves A. The inner cylinder 140 includes a plurality of rings 160 each including one or more projections or tabs 162. The tabs 162 are configured to mate within the grooves A, B of the outer sheath 120 depending on the placement of the cylinder 140 within the outer sheath 120. The rings 160 may be coupled to a sleeve 180 that is attached to or otherwise coupled with the outer circumference of inner cylinder 140. One or both ends of the inner cylinder 140 may include a socket, grip, lever, or other adjustment element 200 to enable the cylinder 140 to be moved (e.g., slid) longitudinally within the sheath 120 to vary the rotational resistance provided by the pivot assembly, as is explained below in more detail.

When tabs 162 of the rings 160 are retained within the circumferential grooves B of the outer sheath 120, cylinder 140 may rotate within sheath 120 with a lower amount of resistance/torque as the cylinder 140 may freely rotate while the tabs 162 pass around the circumferential grooves B. However, when the cylinder 140 is positioned such that one or more of the rings 160 and their respective tabs 162 as aligned with the longitudinal grooves A, a higher amount of resistance is provided against rotation of the cylinder 140 with respect to sheath 120. In such a configuration, the tabs 162 of rings 160 are captured within the grooves A, allowing the cylinder 140 to rotate within sleeve 180 only when the applied force is sufficient to cause the cylinder 140 / sleeve 180 to rotate within the rings 160, which themselves are fixed due to the tabs 162 of the rings 160 being retained with the longitudinal grooves A. Alternatively, rings 160 may be fixed to (or integrated with) sleeve 180 and cylinder 140 may rotate within the sleeve 180 while the tabs 162 remain fixed within the grooves A. In each case, the rotational resistance provided between the cylinder 140 and the sleeve 180 (or rings 160) is greater than the rotational resistance provided between the tabs 162 and circumferential grooves B and cylinder 140 / outer sheath 120, resulting in the pivot assembly providing a variable level of rotational resistance to the foot pedal depending on the placement of the tabs 162 with respect to the grooves A, B.

The pivot assembly may include any number of grooves A, B, rings 160, and associated tabs 162 to provide any desirable amount of configurable resistance (torque). Likewise, the frictional force between the various components of the pivot assembly may be varied through material selection and the use of lubricants to provide a desired amount of rotational resistance. For example, the illustrated examples include four longitudinal grooves A, four circumferential grooves B, four rings 160, and four tabs 162 associated with each ring 160.

To vary the amount of resistance provided by the pivot assembly, the adjustment element 200 may be used by the user to position the cylinder 140 longitudinally within the sheath 120. For example, the user may turn the cylinder 140 until the tabs 162 are aligned with the longitudinal grooves A and then push or pull the cylinder 140 to align one or more of the rings 160 with the circumferential grooves B, where the greater the number of rings 160 that align with grooves A, the greater the drop in output torque / resistance.

The adjustment element 200 may include a control knob configured to allow the user to engage or disengage the inner cylinder 140 within the outer sheath 120, thereby enabling precise positioning to adjust the rotational resistance of the pivot assembly. The control knob may be mounted at one end of the cylinder 140, allowing it to slide or lock along the longitudinal axis within the sheath 120. When the control knob is engaged, it may create a fixed positional lock, securing the inner cylinder 140 at a specific placement within the outer sheath 120, such as aligning the tabs 162 of the rings 160 with either the longitudinal grooves A or the circumferential grooves B. In this configuration, the control knob may apply pressure to maintain the cylinder’s 140 position, resisting unintentional movement.

To adjust the resistance, the user may disengage the control knob, allowing the cylinder 140 to move freely within the sheath 120. This disengagement may be achieved by pulling, pushing, or rotating the control knob, depending on the design, to temporarily release any locking mechanism. The user can then shift the cylinder 140 to the desired position and re-engage the control knob to lock it in place.

The components of the pivot assembly, including the outer sheath 120, inner cylinder 140, and rings 160, may be manufactured from materials selected based on their frictional properties, durability, and compatibility with the expected operational environment of a foot control device. Materials such as metals, polymers, or composites may be used, where metals can offer durability and consistent friction levels, while polymers or composites may reduce weight and allow for molded geometries that simplify assembly. The outer sheath 120, for example, may be made from a high-strength material that resists deformation under load, thereby maintaining the alignment of grooves A, B, while the inner cylinder 140 may be constructed from materials that provide smoother rotational surfaces, such as low-friction polymers or lubricated metals. In some configurations, materials with varying hardness or surface treatments, such as anodizing or PTFE coatings, can be applied to either the inner cylinder 140 or the rings 160 to optimize frictional resistance while minimizing wear.

Lubricants may be selectively applied to certain components of the pivot assembly to further control frictional resistance and facilitate smoother transitions between resistance levels. For instance, a light grease or silicone-based lubricant may be introduced between the inner cylinder 140 and the outer sheath 120 to decrease or manage friction. Likewise, grease or lubricants may be positioned between the rings 160 and the sleeve 180 (and/or between sleeve 180 and cylinder 140) to provide a desired amount of friction.

Therefore, the pivot assembly illustrated in FIGS. 20-22 provides variable resistance to the associated foot pedal’s foot platform by allowing the inner cylinder 140 to be positioned so that its rings 160, specifically the tabs 162 of the rings 160, engage with either longitudinal grooves A or circumferential grooves B within the outer sheath 120. When the tabs align with the longitudinal grooves A, higher resistance occurs, while alignment with the circumferential grooves B reduces resistance, enabling user-controlled adjustment.

Although the invention has been described with reference to the preferred embodiment illustrated in the attached drawing figures, it is noted that equivalents may be employed and substitutions made herein without departing from the scope of the invention as recited in the claims.

1. A trolling motor foot pedal comprising:
a base;
a pivot assembly; and
a foot platform configured to pivotally rotate, via the pivot assembly, with respect to the base,
wherein the pivot assembly includes –
an outer sheath,
an inner axle assembly, wherein the outer sheath and at least a portion of the inner axle assembly are configured to relatively rotate with respect to each other, wherein the inner axle assembly comprises an axle, at least one outer friction ring, and at least one inner friction ring, wherein the at least one inner friction ring is configured to selectively rotate with respect to the at least one outer friction ring,
at least one retaining mechanism configured to selectively restrict rotation of the at least one outer friction ring with respect to the outer sheath,
wherein when the at least one retaining mechanism restricts rotation of the at least one outer friction ring with respect to the outer sheath, the pivot assembly is in a first configuration, and
wherein when the at least one retaining mechanism does not restrict rotation of the at least one outer friction ring with respect to the outer sheath, the pivot assembly is in a second configuration,
wherein the pivot assembly is configured to impart different damping forces against rotation of the foot platform based on whether the pivot assembly is in either the first configuration or the second configuration.

2. The trolling motor foot pedal of claim 1, wherein the at least one inner friction ring is configured to be at least partially received within the at least one outer friction ring.

3. The trolling motor foot pedal of claim 2, wherein the at least one outer friction ring and the at least one inner friction ring each comprises a plurality of spaced apart annular fins.

4. The trolling motor foot pedal of claim 3, wherein the annular fins of the at least one inner friction ring are configured to be received in spaces between the annular fins of the at least one outer friction ring.

5. The trolling motor foot pedal of claim 2, wherein the axle comprises protrusions configured to engage with notches formed in the at least one inner friction ring, such that the at least one inner friction ring is restricted from rotating with respect to the axle.

6. The trolling motor foot pedal of claim 5, wherein in the second configuration of the pivot assembly, the at least one inner friction ring does not rotate when the outer sheath is rotated.

7. The trolling motor foot pedal of claim 6, wherein in the first configuration of the pivot assembly, the at least one retaining mechanism restricts rotation of the at least one outer friction ring with respect to the outer sheath such that the at least one outer friction ring is rotated when the outer sheath is rotated.

8. The trolling motor foot pedal of claim 1, wherein at least one retaining mechanism comprises a set screw configured to extend through the outer sheath and into engagement with the at least one outer friction ring.

9. The trolling motor foot pedal of claim 1, wherein the pivot assembly comprises at least two inner friction rings and at least two outer friction rings.

10. The trolling motor foot pedal of claim 9, wherein the pivot assembly comprises at least one retaining mechanism for each of the at least two outer friction rings.

11. The trolling motor foot pedal of claim 10, wherein the damping force provided against the rotation of the foot platform by the pivot assembly is adjustable based on a number of the at least two outer friction rings restricted from rotating with respect to the outer sheath by the retaining mechanisms.

12. The trolling motor foot pedal of claim 1, wherein the outer sheath includes a mounting surface for rigidly securing the foot platform to the pivot assembly.

13. The trolling motor foot pedal of claim 1, wherein ends of the axle are rigidly attached to connecting ears, and wherein the connecting ears are rigidly secured to the base of the trolling motor foot pedal.

14. A trolling motor foot pedal comprising:
a base;
a pivot assembly; and
a foot platform configured to pivotally rotate, via the pivot assembly, with respect to the base,
wherein the pivot assembly includes –
an outer sheath,
an inner axle assembly, wherein the outer sheath and at least a portion of the inner axle assembly are configured to relatively rotate with respect to each other, wherein the inner axle assembly comprises an axle, at least one outer friction ring, and at least one inner friction ring, wherein the at least one inner friction ring is configured to selectively rotate with respect to the at least one outer friction ring,
at least one retaining mechanism configured to selectively restrict rotation of the at least one outer friction ring with respect to the outer sheath,
wherein the pivot assembly is configured to impart a different damping force against rotation of the foot platform when the at least one retaining mechanism restricts rotation of the at least one outer friction ring than when the at least one retaining mechanism does not restrict rotation of the at least one outer friction ring.

15. The trolling motor foot pedal of claim 14, wherein the at least one inner friction ring is configured to be at least partially received within the at least one outer friction ring.

16. The trolling motor foot pedal of claim 15, wherein the at least one outer friction ring and the at least one inner friction ring each comprises a plurality of spaced apart annular fins, and wherein the annular fins of the at least one inner friction ring are configured to be received in spaces between the annular fins of the at least one outer friction ring.

17. The trolling motor foot pedal of claim 15, wherein the axle is configured to engage with the at least one inner friction ring such that the at least one inner friction ring is restricted from rotating with respect to the axle, and wherein when the at least one retaining mechanism restricts rotation of the at least one outer friction ring with respect to the outer sheath, the at least one outer friction ring rotates with respect to the at least one inner friction ring when the outer sheath is rotated.

18. The trolling motor foot pedal of claim 14, wherein the pivot assembly comprises a plurality of outer friction rings and a plurality of inner friction rings, and wherein the pivot assembly further comprises at least one retaining mechanism for each of the outer friction rings.

19. The trolling motor foot pedal of claim 18, wherein the damping force provided against the rotation of the foot platform by the pivot assembly is adjustable based on a number of the outer friction rings restricted from rotating with respect to the outer sheath by the retaining mechanisms.
